(19) United States
(12) Patent Application Publication
(10) Pub. No.: US 2013/0080123 A1
(43) Pub. Date: Mar. 28, 2013

(54) COMPUTER BASED MODELS OF THREE-DIMENSIONAL FIBROUS WEBS

(71) Applicants: Robert WEBBINK, Sharonville, OH (US); Michael Timothy LOONEY, Blue Ash, OH (US)

(72) Inventors: Robert WEBBINK, Sharonville, OH (US); Michael Timothy LOONEY, Blue Ash, OH (US)

(21) Appl. No.: 13/613,130

(22) Filed: Sep. 13, 2012

Related U.S. Application Data
(60) Provisional application No. 61/539,174, filed on Sep. 26, 2011.

(51) Int. Cl. G06F 17/50

(52) U.S. Cl. 703/1

(57) ABSTRACT

Methods of modeling three-dimensional fibrous webs.

### CROSS REFERENCE TO RELATED APPLICATION

This application claims priority to U.S. Provisional Patent Application Ser. No. 61/539,174, filed on Sep. 26, 2011, the entire disclosure of which is hereby incorporated by reference.

### FIELD

In general, embodiments of the present disclosure relate to fibrous materials. In particular, embodiments of the present disclosure relate to methods of modeling three-dimensional fibrous webs.

### BACKGROUND

A three-dimensional fibrous web is a sheet-like structure of many fibers, wherein the sheet has a caliper that is thicker than a single layer of fibers. To make a three-dimensional fibrous web, fibers are laid down along curvilinear paths in various orientations, with fibers laying on top of each other. It can be difficult to efficiently model fibers that overlay each other in a three-dimensional fibrous web. As a result, it can be difficult to quickly create a model of a three-dimensional fibrous web.

### SUMMARY

The present disclosure provides methods for modeling fibrous webs. The methods can efficiently model fibers that overlay each other in a three-dimensional fibrous web. The methods can be used to quickly create models of three-dimensional fibrous webs. As a result, three-dimensional fibrous webs can be evaluated and modified as computer based models before they are tested as real world things.

### BRIEF DESCRIPTION OF THE DRAWINGS

FIG. 1 illustrates a method of creating a computer based model of a three-dimensional fibrous web.

FIG. 2A illustrates a top view of a single layer of fibers with fiber interferences.

FIG. 2B illustrates an end view of the single layer of fibers of FIG. 2A.

FIG. 2C illustrates a side view of the single layer of fibers of FIG. 2A.

FIG. 3A illustrates a side view of the fibers of FIG. 2C, wherein at least some of the fibers are moving in directions perpendicular to the single layer.

FIG. 3B illustrates a side view of the fibers of FIG. 3A, wherein positions of at least some of the fibers are iteratively adjusted.

FIG. 3C illustrates a side view of the fibers of FIG. 3B, showing original and reduced cross-sectional dimensions for the fibers.

FIG. 3D illustrates a side view of the fibers of FIG. 3C, showing the fibers with reduced cross-sectional dimensions, wherein the fiber interferences have been removed.

FIG. 4A illustrates a side view of the fibers of FIG. 2C, wherein orientations of portions of a fiber are changing in directions perpendicular to the single layer.

FIG. 4B illustrates a side view of the fibers of FIG. 4A, wherein positions of at least some of the fibers are iteratively adjusted.

FIG. 4C illustrates a side view of the fibers of FIG. 4B, showing original and reduced cross-sectional dimensions for the fibers.

FIG. 4D illustrates a side view of the fibers of FIG. 4C, showing the fibers with reduced cross-sectional dimensions, wherein the fiber interferences have been removed.

FIG. 5A illustrates a side view of the fibers of FIG. 2C, wherein positions of at least some of the fibers are iteratively adjusted.

FIG. 5B illustrates a side view of the fibers of FIG. 5A, wherein positions of at least some of the fibers are further iteratively adjusted.

FIG. 5C illustrates a side view of the fibers of FIG. 5B, showing original and reduced cross-sectional dimensions for the fibers.

FIG. 5D illustrates a side view of the fibers of FIG. 5C, showing the fibers with reduced cross-sectional dimensions, wherein the fiber interferences have been removed.

FIG. 6A illustrates a top view of fibers consolidated together at a site that has a perimeter and an allowed interference area that extends outside of the perimeter.

FIG. 6B illustrates a cross-sectional view of a portion of FIG. 6A.

### DETAILED DESCRIPTION

The present disclosure provides methods for creating three-dimensional fibrous webs. The methods can efficiently model fibers that overlay each other. The methods can be used to quickly create models of three-dimensional fibrous webs. As a result, three-dimensional fibrous webs can be evaluated and modified as computer based models before they are tested as real world things.

The methods of the present disclosure can be used to create models of three-dimensional fibrous webs of any kind of fiber, made from any kind of material, using any kind of process, as disclosed herein or as known in the art.

Fibrous webs can be made from animal fibers, plant fibers, mineral fibers, synthetic fibers, etc. Fibrous webs can include short fibers, long fibers, continuous fibers, fibers of varying lengths or cross-sectional geometries, or combinations of any of these. In some cases, a fibrous web can include another material, can be joined to another material, or can be incorporated into another material. In various embodiments, a fibrous web can include multiple layers of fibers, wherein each layer can be configured in a manner that is the same as, or similar to, or different from one or more other layers in the web. For example, a fibrous web can include one or more spunbond layers along with one or more meltblown layers, configured and ordered in any manner known in the art. Fibrous webs can take many forms, such as fabrics, textiles, and composites. Examples of fabrics include fibrous textiles (woven or knitted fabrics), felts, nonwovens, papers, and others. Examples of fibrous composites include composite materials with polymeric fibers, carbon fibers, glass fibers, and/or metal fibers, to name a few. Example fibers may be nonwoven fibers, cellulosic fibers, and/or combinations thereof. Embodiments of the present disclosure can be applied to nonwoven webs and to a wide variety of fibrous webs, such as those described above, as will be understood by one of skill in the art.

As an example, methods of the present disclosure can be used to create models of three-dimensional nonwoven webs. The term “nonwoven web” refers to a sheet-like structure of fibers (sometimes referred to as filaments) that are interlaid in a non-uniform, irregular, or random manner. A three-dimensional nonwoven web can be made from various natural and/or synthetic materials. Exemplary natural materials include cellulosic fibers, such as cotton, jute, pulp, and the like; and also can include reprocessed cellulosic fibers like rayon or viscose. Natural fibers for a nonwoven web can be prepared using various processes such as carding, etc. Exemplary synthetic materials include but are not limited to synthetic thermoplastic polymers that are known to form fibers, which include, but are not limited to, polyolefins, e.g., polyethylene, polypropylene, polybutylene and the like; polyamides, e.g., nylon 6, nylon 6/6, nylon 10, nylon 12 and the like; polyesters, e.g., polyethylene terephthalate, polybutylene terephthalate, polylactic acid and the like; polycarbonate; polystyrene; thermoplastic elastomers; vinyl polymers; polyurethane; and blends and copolymers thereof.

Fibers of a relatively short length, e.g. 40 mm or less, are typically manufactured into a nonwoven web using processes like drylaying, e.g. carding or airlaying, or wetlaying (including paper). Continuous fibers or filaments can be spun out of molten thermoplastics or chemical solutions and formed into a nonwoven web using spunlaying/spunbonding, meltblowing, or electrospinning by example. Another way to form a nonwoven web is by film fibrillation. These processes can also be combined to form composite or layered structures.

The methods of the present disclosure can be implemented by using Computer Aided Design (CAD) and/or Computer Aided Engineering (CAE). CAD is an industrial art wherein designers and/or drafters use software to create and develop computer based geometric models that represent real world things. CAE is a broad area of applied science in which technologists use software and computer based models to simulate the physical behavior of real world things. As examples, CAD and/or CAE can be used to design and create computer based models of all kinds of fibrous materials, such as three-dimensional fibrous webs, including their features, structures, and compositions.

Commercially available software can be used to conduct CAD and CAE. AutoCAD from Autodesk, Inc. in San Rafael, Calif., Pro/Engineer from Parametric Technology Corp. in Needham, Mass., Solid Edge from Siemens in Plano, Tex., and Solidworks from Dassault Systémes, S.A. in Vélizy-Villacoublay, France, are examples of commercially available CAD software. Abaqus, from SIMULIA in Providence, R.I., and LSDyna from Livermore Software Technology Corp. in Livermore, Calif., are examples of commercially available CAE software. Alternatively, CAD and CAE software can be written as custom software. CAD and CAE software can be run on various computer hardware, such as a personal computer, a minicomputer, a cluster of computers, a mainframe, a supercomputer, or any other kind of machine on which program instructions can execute to perform CAD and CAE functions.

CAD and/or CAE software can represent a number of real world things, such as fibrous materials. CAD and/or CAE software can also represent articles that incorporate fibrous materials, such as absorbent articles. An absorbent article can receive, contain, and absorb bodily exudates (e.g. urine, menses, feces, etc.). Absorbent articles include products for sanitary protection, for hygienic use, and the like. Some absorbent articles are wearable. A wearable absorbent article is configured to be worn on or around a lower torso of a body of a wearer. Examples of wearable absorbent articles include diapers and incontinence undergarments.

Some absorbent articles are disposable. A disposable absorbent article is configured to be disposed of after a single use (e.g., not intended to be reused, restored, or laundered). Examples of disposable absorbent articles include disposable diapers, disposable incontinence undergarments, as well as feminine care pads and liners. Some absorbent articles are reusable. A reusable absorbent article is configured to be partly or wholly used more than once. In some embodiments, a reusable absorbent article may be configured such that part of or all of the absorbent article is wear-resistant to laundering or fully launderable. An example of a reusable absorbent article is a diaper with a washable outer cover. In other embodiments, a reusable absorbent article may not be configured to be launderable.

CAD and/or CAE software can also represent other articles that incorporate fibrous materials, including wipes, diaper wipes, body wipes, toilet tissue, facial tissue, wound dressings, handkerchiefs, household wipes, window wipes, bathroom wipes, surface wipes, countertop wipes, floor wipes, and other articles, as will be understood by one of skill in the art.

In general, computer based models can be created as described below, with general references to a computer based model of a fiber. A computer based model that represents a fiber can be created by providing dimensions and material properties to modeling software and by generating a mesh for the fiber using meshing software.

A computer based model of a fiber can be created with dimensions that are similar to or the same as dimensions that represent a real world fiber. These dimensions can be determined by measuring actual samples, by using known values, or by estimating values. Alternatively, a model of a fiber can be configured with dimensions that do not represent a real world fiber. For example, a model of a fiber can represent a new variation of a fiber or can represent an entirely new fiber. In these examples, dimensions for the model can be determined by varying actual or known values, by estimating values, or by generating new values. The model can be created by putting values for the dimensions of parts of the fiber into the modeling software.

The computer based model of the fiber can be created with material properties that are similar to or the same as material properties that represent a real world fiber. These material properties can be determined by measuring actual samples, by using known values, or by estimating values. Alternatively, a model of a fiber can be configured with material properties that do not represent a real world fiber. For example, a model of a fiber can represent a new variation of a real world fiber or can represent an entirely new fiber. In these examples, material properties for the model can be determined by varying actual or known values, by estimating values, or by generating new values.

The computer based model of the fiber can be created with a mesh for the parts of the fiber. A mesh is a collection of small, connected geometric shapes that define the set of discrete elements in a CAD and/or CAE computer based model. The type of mesh and/or the size of elements can be controlled with user inputs into the meshing software, as will be understood by one of ordinary skill in the art. As examples, a segment of a fiber can be represented by using one or more beam elements, truss elements, solid elements, other kinds of elements, or combinations of any of these. Each computer based model of a fiber segment or a fiber, in the present disclosure, can be created in these ways.

Program instructions can execute, causing a device to perform the methods disclosed herein, including any alternative embodiments. The execution can be performed with software, hardware, and combinations thereof, as described herein. These program instructions and any of these representations can be stored on a computer-readable medium.

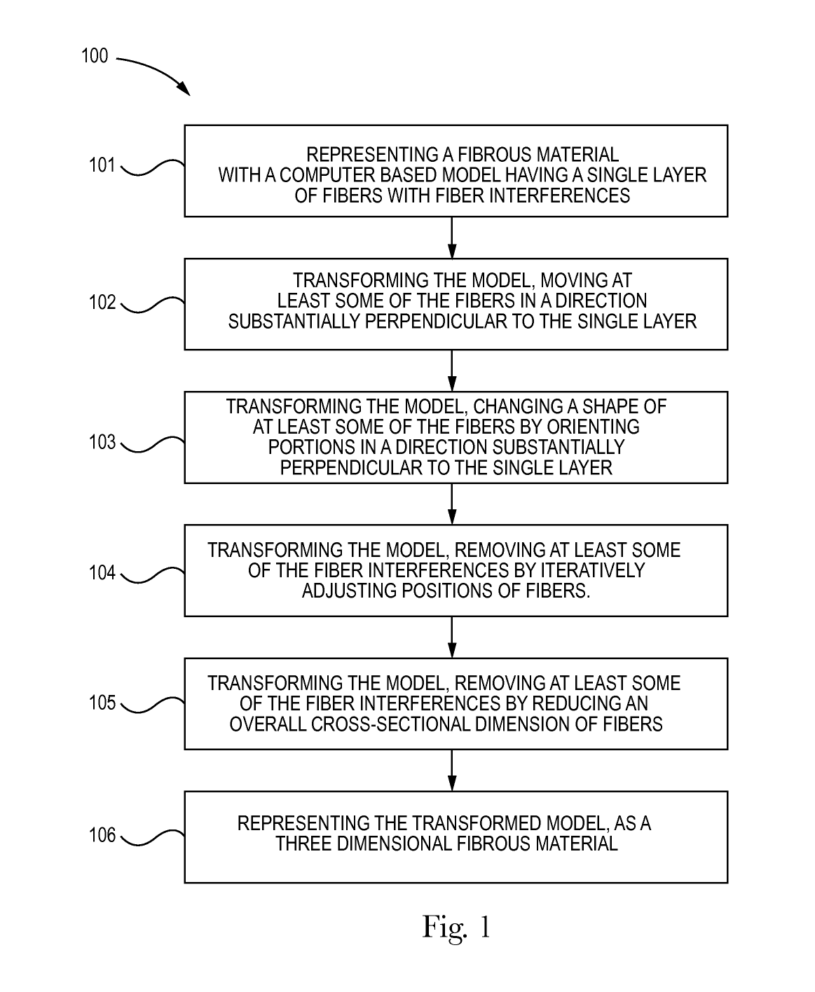

FIG. 1 illustrates a method 100 of creating a computer based model of a three-dimensional fibrous web. Although the steps 101-106 are described in numerical order in the present disclosure, in various embodiments some or all of these steps can be performed in other orders, and/or at overlapping times, and/or at the same time, as will be understood by one of ordinary skill in the art. Program instructions in CAD and/or CAE software (and/or other software) can execute to perform each step in the method 100, as described below.

The method 100 includes a first step 101 of representing a fibrous material with a computer based model of the fibrous material, wherein the fibrous material includes a plurality of fibers, a plurality of fiber interferences that apply to at least some of the fibers, and the plurality of fibers is a single layer of fibers. Program instructions can execute to represent the fibrous material with a model, as described above.

The method 100 includes steps 102-105 of transforming the computer based model of the fibrous material from the first step 101, removing at least some of the fiber interferences to form a three-dimensional fibrous material.

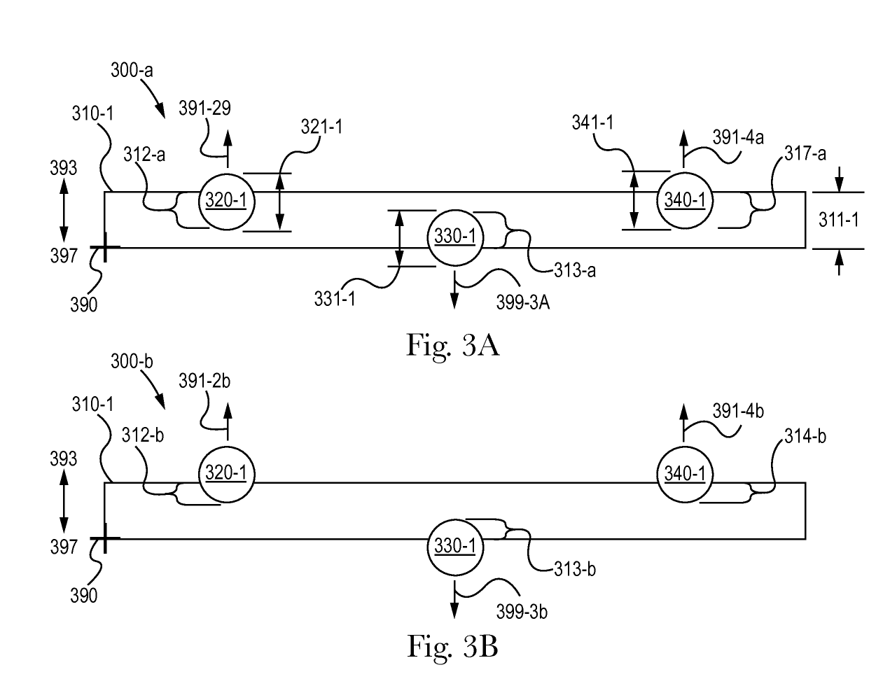

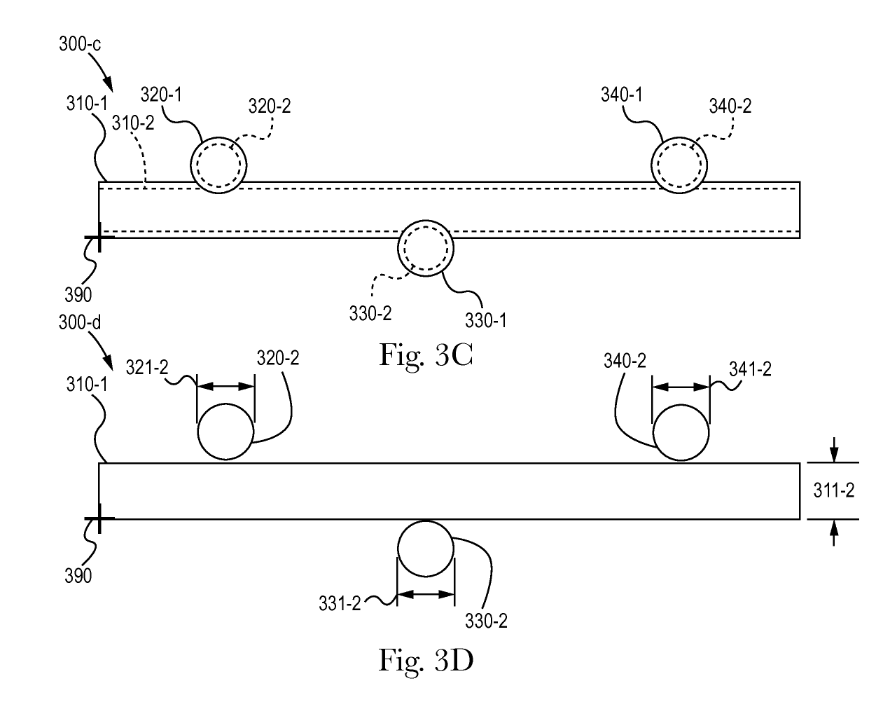

The method 100 includes a second step 102 of moving at least some of the fibers, in a direction that is substantially perpendicular to the single layer. Without wishing to be bound by the theory, it is believed that the performance of the second step 102 in advance of the fourth step 104 tends to create a layering effect, as described in connection with the embodiment of FIG. 3A. Program instructions can execute to represent the model, transformed by the second step 102, as described above. In various embodiments, the second step 102 can be omitted from the method 100.

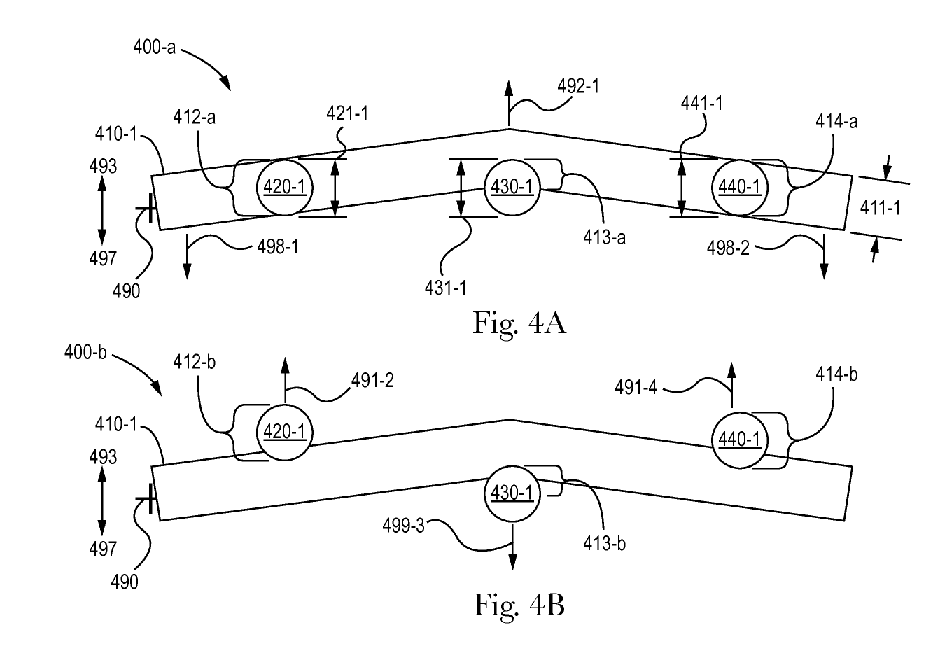

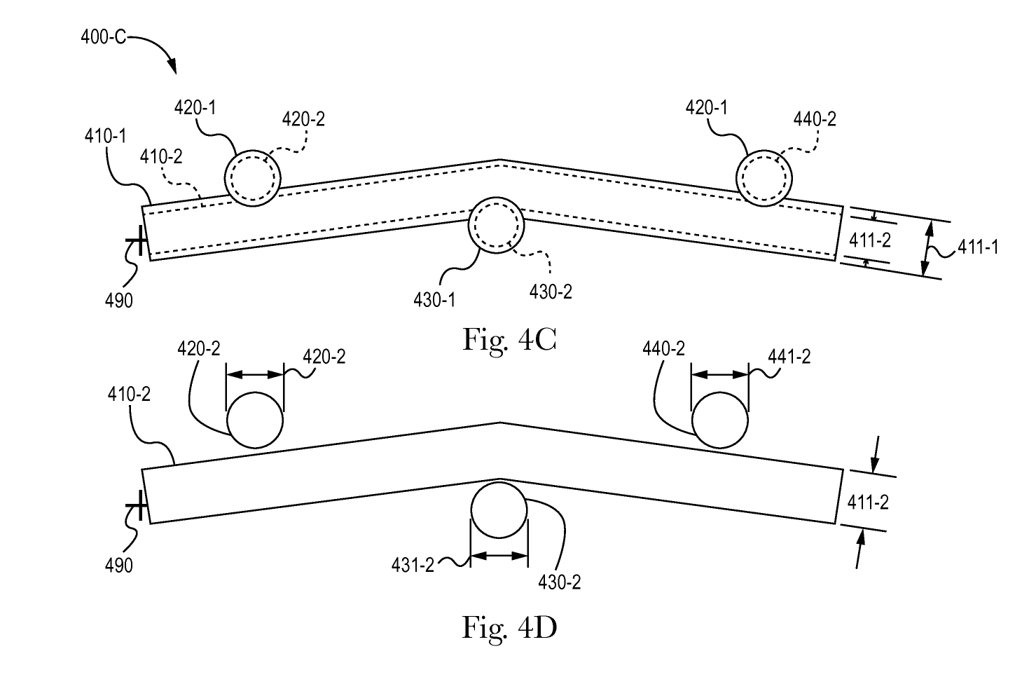

The method 100 includes a third step 103 of changing a shape of at least some of the fibers by orienting a first portion of a fiber in an upward direction and orienting a second portion of the fiber in a downward direction. Without wishing to be bound by the theory, it is believed that the performance of the third step 103 in advance of the fourth step 104 tends to create a knitting effect, as described below in connection with the embodiment of FIG. 4A. Program instructions can execute to represent the model, transformed by the third step 103, as described above. In various embodiments, the third step 103 can be omitted from the method 100.

The method 100 includes a fourth step 104 of removing at least some of the fiber interferences with an iterative process of adjusting one or more positions of one or more portions of at least some of the fibers, wherein the process is performed until one or more certain criteria are met. For example, the iterative process can be performed until the fiber interferences apply to less than 10% of the fibers. As another example, the iterative process can be performed until a largest interference in the plurality of fibers is less than or equal to 20% of the overall cross-sectional dimension of the plurality of fibers, or less than or equal to 10% of the overall cross-sectional dimension of the plurality of fibers, or even less than or equal to 1% of the overall cross-sectional dimension of the plurality of fibers. As a further example, the iterative process can be performed until all fiber interferences are removed from the fibers. Program instructions can execute to represent the model, transformed by the fourth step 104, as described above. Various commercially available software packages offer functions that remove interferences between objects (sometimes referred to as resolving overclosures). For example, Abaqus offers a strain free displacement function, which iteratively adjusts the positions of objects that are interfering with each other, so as to reduce and/or eliminate the interference(s). Custom software can also be provided to provide the same functionality. In various embodiments, the fourth step 104 can be omitted from the method 100.

The method 100 includes a fifth step 105 of removing at least some of the fiber interferences by reducing an overall cross-sectional dimension of at least some of the fibers. In various embodiments, the fifth step can include reducing an overall cross-sectional dimension of at least some of the fibers by a particular distance that is based on a largest interference remaining in the fibers, after previous steps to remove at least some of the interferences. For example, the reducing can include reducing an overall cross-sectional dimension of at least some of the fibers by the particular distance, which is less than or equal to the largest interference plus 20%. As another example, the reducing can include reducing an overall cross-sectional dimension of at least some of the fibers by the particular distance, which is less than or equal to the largest interference plus 10%. As a further example, the reducing can include reducing an overall cross-sectional dimension of at least some of the fibers by the particular distance, which is less than or equal to the largest interference. Still further, the reducing can be performed until all fiber interferences are removed from the fibers. Program instructions can execute to represent the model, transformed by the fifth step 105, as described above. In various embodiments, the fifth step 105 can be omitted from the method 100.

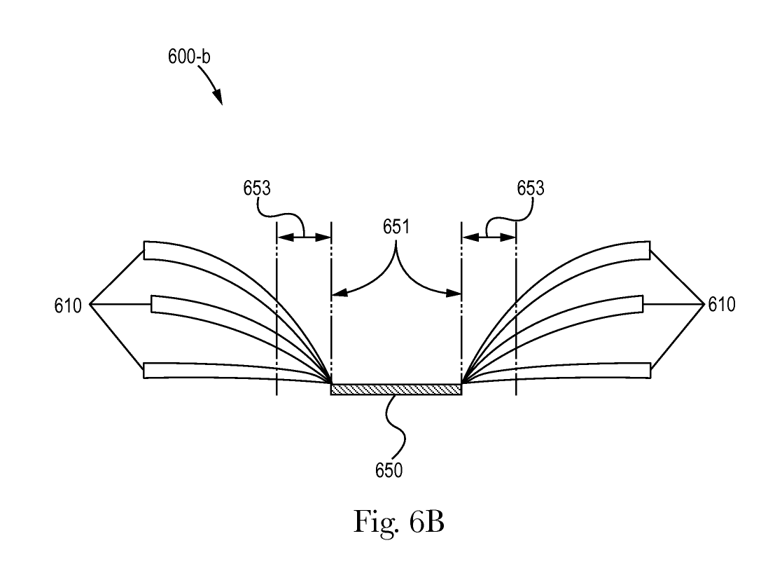

In various embodiments, program instructions can execute such that the steps 102-105 for removing at least some of the fiber interferences may exclude certain fibers or certain portions of fibers. For example, where the representing of the fibrous material (in the first step 101) includes representing a processed fibrous material with a computer based model of a bonded fibrous material, and wherein at least some of the fibers are consolidated together at one or more sites (such as bond sites), each of the sites can have a perimeter and an allowed interference area that extends outside of the perimeter, wherein the removing steps exclude any fiber interferences inside of the allowed interference areas and also exclude any fiber interferences inside of the perimeter of the sites. This is described and illustrated in the embodiment of FIGS. 6A and 6B.

The method 100 includes a sixth step 106 of representing the transformed fibrous material with from steps 102-105 with a computer based model of the transformed fibrous material. Program instructions can execute to represent the transformed model, as described above.

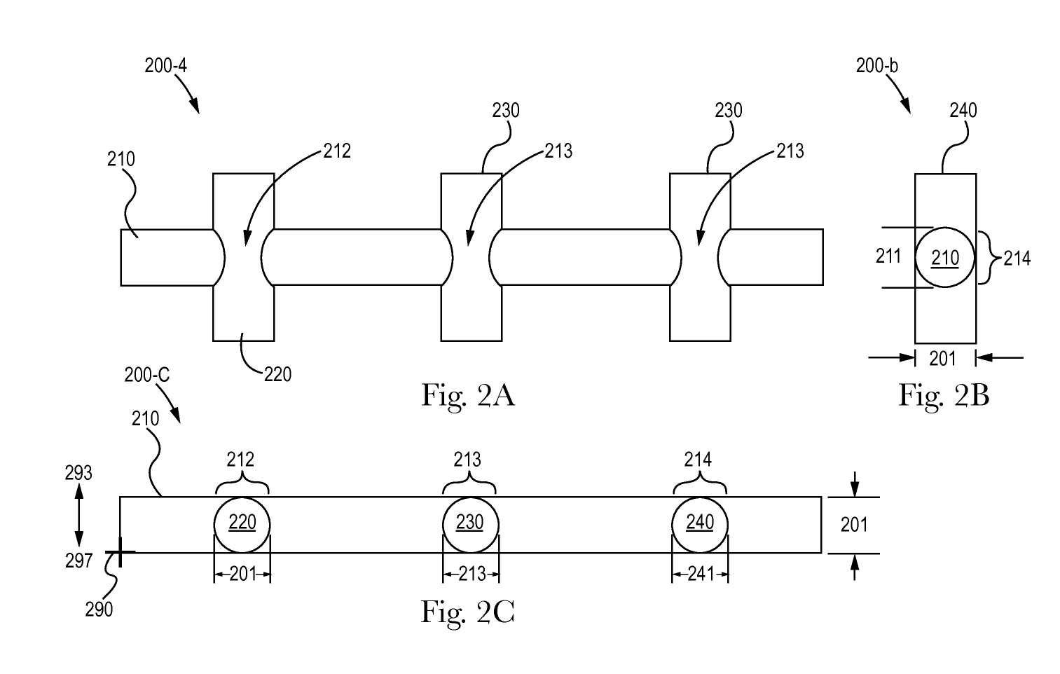

FIGS. 2A-6B illustrate simplified arrangements of fibers, intended to illustrate the relative position and orientation of fiber segments that are processed according to steps from the method 100 of FIG. 1.

FIG. 2A represents the first step 101 of the method 100 of FIG. 1.

FIG. 2A illustrates a top view of a single layer of fibers 200-a with fiber interferences 212, 213, and 214. As used herein, the term “single layer of fibers” refers to a number of fibers that lie in substantially the same plane. The single layer of fibers 200-a includes a fiber 210 that intersects fibers 220, 230, and 240. The intersection of fiber 210 and fiber 220 creates fiber interference 212, the intersection of fiber 210 and fiber 230 creates fiber interference 213, and the intersection of fiber 210 and fiber 240 creates fiber interference 214.

Although the fibers are shown in the figures as having a generally circular cross-sectional shape, it is specifically within the scope of the present disclosure to have fibers having any suitable polygonal cross-sectional shapes, such as ovate, rectangular, square, triangular, semi-circular, ovate and hollow, circular and hollow, and trilobal (e.g., clover shaped), for example.

FIG. 2B illustrates an end view of a single layer of fibers 200-b, which is the single layer of fibers 200-a of FIG. 2A. The fiber 210 has an overall cross-sectional dimension 211. The single layer of fibers 200-b has an overall thickness, which is equal to the overall cross-sectional dimension 211.

FIG. 2C illustrates a side view of a single layer of fibers 200-c, which is the single layer of fibers 200-a of FIG. 2A. The fiber 220 has an overall cross-sectional dimension 221, the fiber 230 has an overall cross-sectional dimension 231, and the fiber 240 has an overall cross-sectional dimension 241, each of which is equal to the overall cross-sectional dimension 211 of the fiber 210. FIG. 2C also includes a reference point 290, an upward direction 293 that is perpendicular to the single layer of fibers 200-c, and a downward direction 297 that is perpendicular to the single layer of fibers 200-c and opposite from the upward direction 293.

For ease of illustration, single layer of fibers 200-b includes four fibers, with each fiber illustrated as a round fiber having the same diameter. However, in various embodiments, a single layer of fibers can include any combination of any number or any kind of fibers (produced by any method), including fibers of varying size, shape, material, and configuration, as described herein, or as known in the art.

FIGS. 3A-3D represent the second step 102, the fourth step 104, the fifth step 105, and the sixth step 106 of the method 100 of FIG. 1, as applied to the single layer of fibers 200-c of FIG. 2C. Altogether, FIGS. 2A-3D represent an embodiment of the method 100 of FIG. 1.

FIG. 3A represents the second step 102 of the method 100 of FIG. 1, as applied to the single layer of fibers 200-c of FIG. 2C. FIG. 3A illustrates a side view of fibers 300-a, which are the fibers from the single layer of fibers 200-a of FIG. 2A, with like-numbered elements configured in the same manner, except as described below. In FIG. 3A, fiber 320-1 is moving 391-2a upward 393, which reduces the size of its interference with fiber 310-1 from fiber interference 212 in FIG. 2C to fiber interference 312-a. Fiber 330-1 is moving 399-3a downward 397, which reduces the size of its interference with fiber 310-1 from fiber interference 213 in FIG. 2C to fiber interference 313-a. Fiber 340-1 is moving 391-4a upward 393, which reduces the size of its interference with fiber 310-1 from fiber interference 214 in FIG. 2C to fiber interference 314-a. Without wishing to be bound by the theory, it is believed that the performance of the second step 102 in advance of the fourth step 104 tends to create a layering effect, wherein, throughout the resulting three-dimensional fibrous web (shown in FIG. 3D), relatively more fibers tend to group together in parallel planes.

FIG. 3B represents the fourth step 104 of the method 100 of FIG. 1, as applied to the single layer of fibers 300-a of FIG. 3A. FIG. 3B illustrates a side view of fibers 300-b, which are the fibers 300-a of FIG. 3A, configured as described below. In FIG. 3B, the position of fiber 320-1 is iteratively being adjusted 391-2b upward 393, which reduces the size of its interference with fiber 310-1 from fiber interference 312-a to fiber interference 312-b. The position of fiber 330-1 is iteratively being adjusted 399-3b downward 397, which reduces the size of its interference with fiber 310-1 from fiber interference 313-a to fiber interference 313-b. The position of fiber 340-1 is iteratively being adjusted 391-4b upward 393, which reduces the size of its interference with fiber 310-1 from fiber interference 314-a to fiber interference 314-b.

FIGS. 3C and 3D together represent the fifth step 105 and the sixth step 106 of the method 100 of FIG. 1, as applied to the single layer of fibers 300-b of FIG. 3B. FIG. 3C illustrates a side view of fibers 300-c, which are the fibers 300-b of FIG. 3B, configured as described below. FIG. 3C uses dashed lines to show fibers 310-2, 320-2, 330-2, and 340-2 with reduced cross-sectional dimensions, corresponding to fibers 310-1, 320-1, 330-1, and 340-1 respectively.

FIG. 3D illustrates a side view of fibers 300-d, which are the fibers of FIG. 3C having reduced cross-sectional dimensions. In FIG. 3D, the cross-sectional dimension of fiber 320-1 is reduced from 321-1 to 321-2, the cross-sectional dimension of fiber 330-1 is reduced from 331-1 to 331-2, and the cross-sectional dimension of fiber 340-1 is reduced from 341-1 to 341-2. As a result of the second step 102, the fourth step 104, and the fifth step 105 from the method 100 of FIG. 1, all of the fiber interferences have been removed from the fibers 300-d. The fibers 300-d are no longer a single layer of fibers, but are represented as a three-dimensional fibrous web, as described in the sixth step 106 of the method 100.

FIGS. 4A-4D represent the third step 103, the fourth step 104, the fifth step 105, and the sixth step 106 of the method 100 of FIG. 1, as applied to the single layer of fibers 200-c of FIG. 2C. Altogether, FIGS. 2A and 4A-4D represent an embodiment of the method 100 of FIG. 1.

FIG. 4A represents the third step 103 of the method 100 of FIG. 1, as applied to the single layer of fibers 200-c of FIG. 2C. FIG. 4A illustrates a side view of fibers 400-a, which are the fibers from the single layer of fibers 200-a of FIG. 2A, with like-numbered elements configured in the same manner, except as described below. In FIG. 4A, end portions of the fiber 401-1 are being oriented 498-1 and 498-2 downward 497, and a middle portion of the fiber 401-a is being oriented 492-1 upward 493, which changes the shape of the fiber 401-1. The change in the shape of the fiber 401-1 reduces the size of its interference with fiber 420-1 from fiber interference 212 in FIG. 2C to fiber interference 412-a, reduces the size of its interference with fiber 430-1 from fiber interference 213 in FIG. 2C to fiber interference 413-a, and reduces the size of its interference with fiber 440-1 from fiber interference 214 in FIG. 2C to fiber interference 414-a. Without wishing to be bound by the theory, it is believed that the performance of the third step 103 in advance of the fourth step 104 tends to create a knitting effect, wherein, throughout the resulting three-dimensional fibrous web (shown in FIG. 3D), relatively more individual fibers tend to follow pathways that thread upward and downward numerous times throughout the web.

FIG. 4B represents the fourth step 104 of the method 100 of FIG. 1, as applied to the single layer of fibers 400-a of FIG. 4A. FIG. 4B illustrates a side view of fibers 400-b, which are the fibers 400-a of FIG. 4A, configured as described below. In FIG. 4B, the position of fiber 420-1 is iteratively being adjusted 491-2 upward 493, which reduces the size of its interference with fiber 410-1 from fiber interference 412-a to fiber interference 412-b. The position of fiber 430-1 is iteratively being adjusted 499-3 downward 497, which reduces the size of its interference with fiber 410-1 from fiber interference 413-a to fiber interference 413-b. The position of fiber 440-1 is iteratively being adjusted 491-4b upward 493, which reduces the size of its interference with fiber 410-1 from fiber interference 414-a to fiber interference 414-b.

FIGS. 4C and 4D together represent the fifth step 105 and the sixth step 106 of the method 100 of FIG. 1, as applied to the single layer of fibers 400-b of FIG. 4B. FIG. 4C illustrates a side view of fibers 400-c, which are the fibers 400-b of FIG. 4B, configured as described below. FIG. 4C uses dashed lines to show fibers 410-2, 420-2, 430-2, and 440-2 with reduced cross-sectional dimensions, corresponding to fibers 410-1, 420-1, 430-1, and 440-1 respectively.

FIG. 4D illustrates a side view of fibers 400-d, which are the fibers of FIG. 4C having reduced cross-sectional dimensions. In FIG. 4D, the cross-sectional dimension of fiber 420-1 is reduced from 421-1 to 421-2, the cross-sectional dimension of fiber 430-1 is reduced from 431-1 to 431-2, and the cross-sectional dimension of fiber 440-1 is reduced from 441-1 to 441-2. As a result of the second step 102, the fourth step 104, and the fifth step 105 from the method 100 of FIG. 1, all of the fiber interferences have been removed from the fibers 400-d. The fibers 400-d are no longer a single layer of fibers, but are represented as a three-dimensional fibrous web, as described in the sixth step 106 of the method 100.

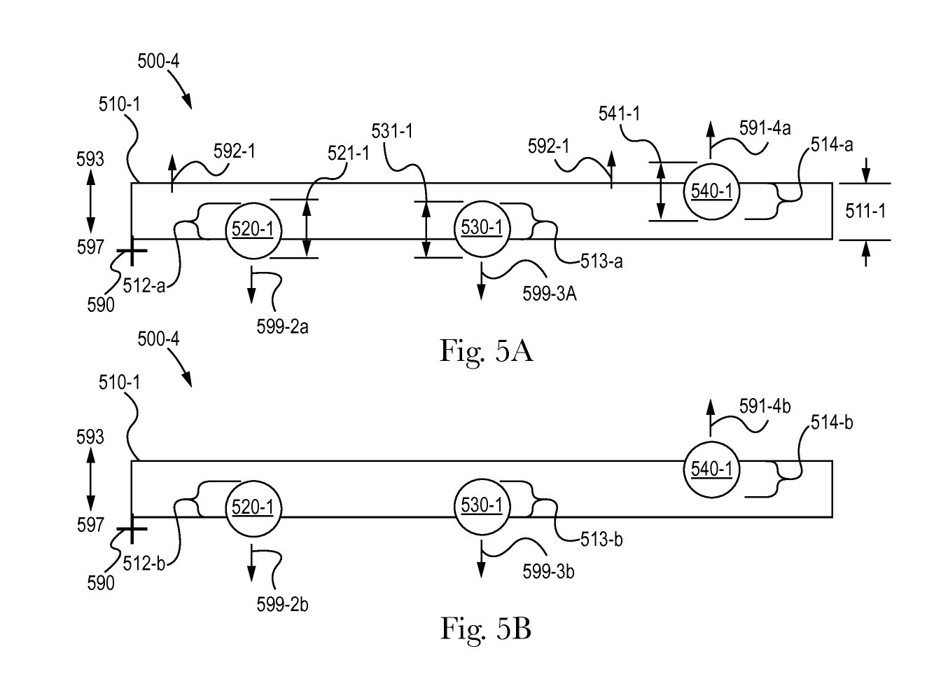

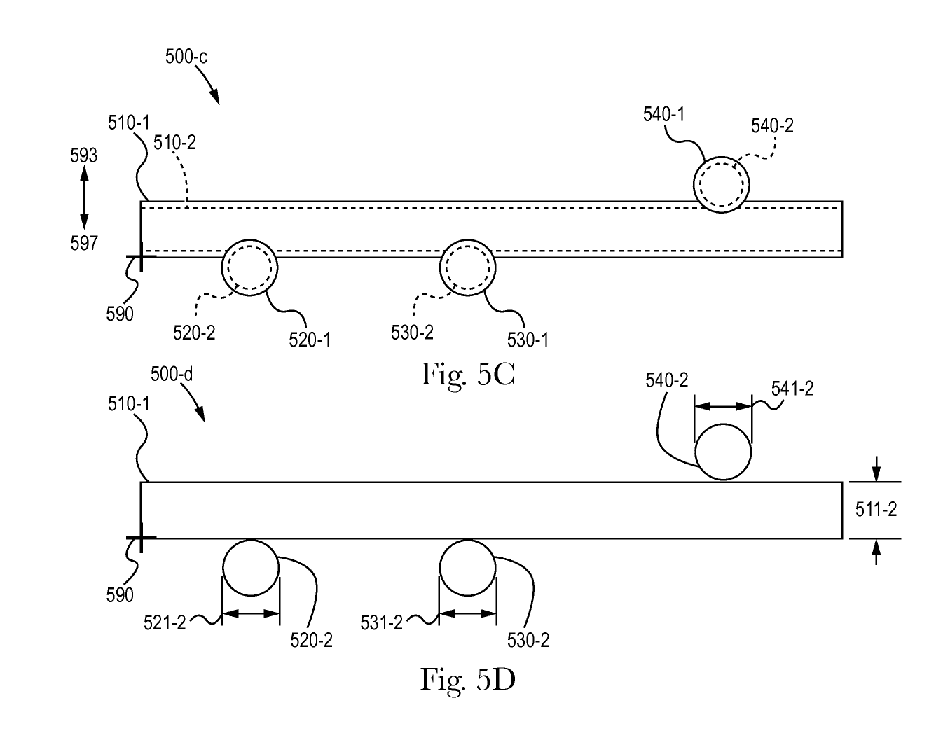

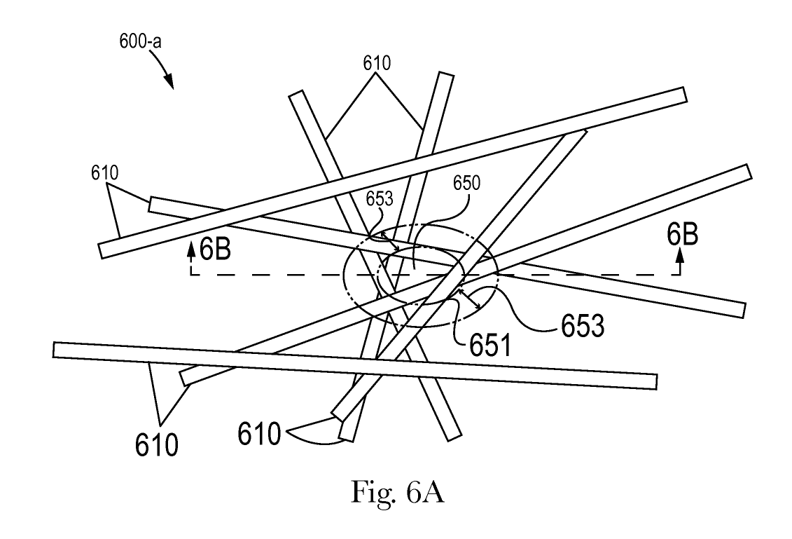

FIGS. 5A-5D represent the fourth step 104, the fifth step 105, and the sixth step 106 of the method 100 of FIG. 1, as applied to the single layer of fibers 200-c of FIG. 2C. Altogether, FIGS. 2A and 5A-5D represent an embodiment of the method 100 of FIG. 1.

FIG. 5A represents the fourth step 104 of the method 100 of FIG. 1, as applied to the single layer of fibers 200-c of FIG. 2C. FIG. 5A illustrates a side view of fibers 500-a, which are the fibers from the single layer of fibers 200-a of FIG. 2A, with like-numbered elements configured in the same manner, except as described below. In FIG. 5A, the position of fiber 510-1 is iteratively being adjusted 592-1 upward 593, and away from fibers 520-1 and 530-1, which reduces the size of its interferences with fibers 520-1 and 530-1, as described below. The position of fiber 520-1 is iteratively being adjusted 599-2a downward 597, and away from fiber 510-1, which reduces the size of its interference with fiber 510-1 from fiber interference 512 to fiber interference 512-a. The position of fiber 530-1 is iteratively being adjusted 599-3a downward 597, and away from fiber 510-1, which reduces the size of its interference with fiber 510-1 from fiber interference 513 to fiber interference 513-a. The position of fiber 540-1 is iteratively being adjusted 591-4a upward 593, and away from fiber 510-1, which reduces the size of its interference with fiber 510-1 from fiber interference 514 to fiber interference 514-a.

FIG. 5B also represents the fourth step 104 of the method 100 of FIG. 1, as applied to the single layer of fibers 500-a of FIG. 5A. FIG. 5B illustrates a side view of fibers 500-b, which are the fibers from the single layer of fibers 500-b of FIG. 5A, with like-numbered elements configured in the same manner, except as described below. In FIG. 5B, the position of fiber 520-1 is iteratively being adjusted 599-2b downward 597, and away from fiber 510-1, which reduces the size of its interference with fiber 510-1 from fiber interference 512-a to fiber interference 512-b. The position of fiber 530-1 is iteratively being adjusted 599-3b downward 597, and away from fiber 510-1, which reduces the size of its interference with fiber 510-1 from fiber interference 513-a to fiber interference 513-b. The position of fiber 540-1 is iteratively being adjusted 591-4b upward 593, and away from fiber 510-1, which reduces the size of its interference with fiber 510-1 from fiber interference 514-a to fiber interference 514-b.

FIGS. 5C and 5D together represent the fifth step 105 and the sixth step 106 of the method 100 of FIG. 1, as applied to the single layer of fibers 500-b of FIG. 5B. FIG. 5C illustrates a side view of fibers 500-c, which are the fibers 500-b of FIG. 5B, configured as described below. FIG. 5C uses dashed lines to show fibers 510-2, 520-2, 530-2, and 540-2 with reduced cross-sectional dimensions, corresponding to fibers 510-1, 520-1, 530-1, and 540-1 respectively.

FIG. 5D illustrates a side view of fibers 500-d, which are the fibers of FIG. 5C having reduced cross-sectional dimensions. In FIG. 5D, the cross-sectional dimension of fiber 520-1 is reduced from 521-1 to 521-2, the cross-sectional dimension of fiber 530-1 is reduced from 531-1 to 531-2, and the cross-sectional dimension of fiber 540-1 is reduced from 541-1 to 541-2. As a result of the second step 102, the fourth step 104, and the fifth step 105 from the method 100 of FIG. 1, all of the fiber interferences have been removed from the fibers 500-d. The fibers 500-d are no longer a single layer of fibers, but are represented as a three-dimensional fibrous web, as described in the sixth step 106 of the method 100.

FIG. 6A illustrates a top view 600-a of fibers 610 consolidated together at a site 650 that has a perimeter 651 and an allowed interference area 653 that extends outside of the perimeter. Program instructions can execute to allow the fibers 610 to interfere with each other in the interference area 653 and at the site 650.

FIG. 6B illustrates a cross-sectional view 600-b of a portion of FIG. 6A.

Computer based models of three-dimensional fibrous webs, as described in the present disclosure, can be used in simulated testing, to determine their performance characteristics. For example, in one kind of simulated testing, various boundary conditions can be applied to a computer based model of a fibrous web, to determine the performance of the web. The model of the web can be pulled in tension, while measuring the applied forces and/or displacements as well as the stresses, strains, and deformations experienced by the web, over a period of time. These measurements can then be used to calculate various mechanical properties of the modeled web, such as its stiffness, elasticity, tensile strength, strain energy, neckdown, etc. In some embodiments, a computer based model of a fibrous material can be used in simulated testing to evaluate various geometries of the material, such as its thickness, density, topology, fluid permeability, porosity, pressure resistance, etc. Simulated testing can also be used to evaluate other properties of the material, such as its filtering ability, acoustic properties, appearance, softness, ability to cleanse, etc.

A computer based model of a fibrous material can be easily varied, to determine how such variations affect the mechanical properties of the web. As an example, various fiber laydown patterns, fiber sizes, and/or material basis weights can be applied to a model of a fibrous web, to determine how theses parameters affect the performance of the web. In some embodiments, a computer based model of a fibrous material can be systematically varied in a virtual design of experiments that tests many variations of several aspects of the model. The empirical results of the virtual experiments can be statistically analyzed to determine the relationship between the variations and the mechanical properties of the web.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising:
representing a fibrous material with a computer based model of the fibrous material, wherein the fibrous material includes a plurality of fibers, a plurality of fiber interferences that apply to at least some of the fibers, and the plurality of fibers is a single layer of fibers;
transforming the computer based model of the fibrous material to form a three-dimensional fibrous material; and
representing the transformed fibrous material with a computer based model of the transformed fibrous material.

2. The method of claim 1, wherein the representing of the fibrous material includes representing the fibrous material with the computer based model of the fibrous material, wherein the fibers are represented by elements selected from a group, the group including:
beam elements, and
truss elements.

3. The method of claim 2, wherein the representing includes representing the transformed fibrous material with a computer based model of the transformed fibrous material, wherein the fibers of transformed fibrous materials are represented by solid elements.

4. The method of claim 1, wherein the transforming includes removing at least some of the fiber interferences.

5. The method of claim 4, wherein the removing is an iterative process that is performed until the fiber interferences apply to less than 10% of the fibers.

6. The method of claim 4, wherein the plurality of fibers has an overall cross-sectional dimension, and the removing is an iterative process that is performed until a largest interference in the plurality of fibers is less than or equal to 20% of the overall cross-sectional dimension of the plurality of fibers.

7. The method of claim 6, wherein the plurality of fibers has an overall cross-sectional dimension, and the removing is an iterative process that is performed until the largest interference in the plurality of fibers is less than or equal to 10% of the overall cross-sectional dimension of the plurality of fibers.

8. The method of claim 7, wherein the plurality of fibers has an overall cross-sectional dimension, and the removing is an iterative process that is performed until the largest interference in the plurality of fibers is less than or equal to 1% of the overall cross-sectional dimension of the plurality of fibers.

9. The method of claim 4, wherein the removing is an iterative process that is performed until all fiber interferences are removed from the fibers.

10. The method of claim 4, wherein:
the representing of the fibrous material includes representing a processed fibrous material with a computer based model of the bonded fibrous material, wherein at least some of the fibers are consolidated together at one or more sites, and each of the sites has a perimeter; and
the transforming includes removing at least some of the fiber interferences outside of the perimeter, and the removing excludes any of the fiber interferences inside of the perimeter.

11. The method of claim 10, wherein:
the representing of the fibrous material includes representing a processed fibrous material with a computer based model of the bonded fibrous material, wherein each of the sites has an allowed interference area that extends outside of the perimeter; and
the transforming includes removing at least some of the fiber interferences outside of the allowed interference areas, and the removing excludes any of the fiber interferences inside of the allowed interference areas.

12. The method of claim 4, wherein the removing includes adjusting one or more positions of one or more portions of at least some of the fibers.

13. The method of claim 12, wherein, before the adjusting, the method includes moving at least some of the fibers, in a direction that is substantially perpendicular to the single layer.

14. The method of claim 12, wherein, before the adjusting, the method includes changing a shape of at least a portion of at least some of the fibers by orienting the portions in a direction that is at least partially perpendicular to the single layer.

15. The method of claim 14, wherein the changing includes changing a shape of at least some of the fibers by orienting a first portion of a fiber in an upward direction and orienting a second portion of the fiber in a downward direction.

16. The method of claim 12, wherein the adjusting is a first process for removing fiber interferences, and the removing includes a second process for removing at least some of the fiber interferences.

17. The method of claim 16, wherein the second process includes reducing an overall cross-sectional dimension of at least some of the fibers.

18. The method of claim 17, wherein the second process includes reducing an overall cross-sectional dimension of all of the fibers.

19. The method of claim 17, wherein the second process includes reducing a diameter of at least some of the fibers.

20. The method of claim 17, wherein:
the first process is performed until a largest interference in the plurality of fibers remains, and
the second process includes reducing an overall cross-sectional dimension of at least some of the fibers by a particular distance that is based on the largest interference.

21. The method of claim 17, wherein the second process includes reducing the overall cross-sectional dimension of at least some of the fibers by the particular distance, which is less than or equal to the largest interference plus 20%.

22. The method of claim 21, wherein the second process includes reducing the overall cross-sectional dimension of at least some of the fibers by the particular distance, which is less than or equal to the largest interference plus 10%.

23. The method of claim 22, wherein the second process includes reducing the overall cross-sectional dimension of at least some of the fibers by the particular distance, which is less than or equal to the largest interference.

24. The method of claim 17, wherein the second process is performed until all fiber interferences are removed from the fibers.

25. The method of claim 1, wherein the fibers comprise nonwoven fibers, cellulosic fibers, or combinations thereof.

26. A computer readable medium having instructions for causing a device to perform a method, the method comprising:
representing a fibrous material with a computer based model of the fibrous material, wherein the fibrous material includes a plurality of fibers, a plurality of fiber interferences that apply to at least some of the fibers, and the plurality of fibers is a single layer of fibers;
transforming the computer based model of the fibrous material to form a three-dimensional fibrous material; and
representing the transformed fibrous material with a computer based model of the transformed fibrous material.
